(19) United States
(12) Patent Application Publication
(10) Pub. No.: US 2013/0271292 A1
(43) Pub. Date: Oct. 17, 2013

(54) Driver Alert and Monitoring System

(71) Applicant: James Andrew McDermott, The Woodlands, TX (US)

(72) Inventor: James Andrew McDermott, The Woodlands, TX (US)

(21) Appl. No.: 13/646,817

(22) Filed: Oct. 8, 2012

Related U.S. Application Data
(60) Provisional application No. 61/545,158, filed on Oct. 9, 2011.

(51) Int. Cl. G08G 1/0967

(52) U.S. Cl. CPC G08G 1/096783
USPC 340/905

(57) ABSTRACT

This invention is a new approach to dealing with the age old problems of maneuvering a motor vehicle through the myriad of obstacles found on most roadways, by proactively appraising the vehicle operator of ACTIONS (immediate and soon to be immediate) they need to take, and by monitoring vehicle speed vs. the current posted speed, and alerting the operator accordingly.

### CROSS-REFERENCE TO RELATED APPLICATIONS

This invention was originally filed as a Provisional Utility Patent on Oct. 9, 2011 and was assigned Application No. 61/545,158.

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THIS INVENTION

This invention pertains to detecting, interpreting and displaying (audio and visual) traffic signs and signals to the driving motorist in real time, in a discrete yet eye catching manner. This invention uses Radio Frequency Identification (RFID) technology coupled with a small plug and play processor and display unit mounted in the vehicle. A RFID reader is attached to the processor, and RFID tags are embedded in road pavement, or mounted to horizontal or vertical posts or other physical devices along the roadway, approximately 300 feet prior to reaching the actual physical traffic sign or signal.

This invention came about as a result of observing dangerous driver activity because the driver was not aware of a road hazard (e.g. sharp curve) or permanent or temporary restriction (e.g. stop sign, posted speed limit, school zone speed reduction, etc.) or due to texting, phone use, inattention, unfamiliarity, or in some instances blocked or unreadable signage due to fog, smoke, or other obstructions.

### BRIEF SUMMARY OF THIS INVENTION

The OBJECT of this invention is to proactively yet unobtrusively alert the motor vehicle driver to road conditions that require their immediate or soon to be immediate action, in order to safely operate their vehicle. This invention further strives to overcome issues the driver faces when recognizing or reading road signs and signals, due to inattention or due to obstacles such as fog, haze, rain, dirty or even damaged signage, since the RFID tag that identifies that sign or signal is accessed via radio frequency which sees through most obstacles, and the tag is located some 300 feet before the physical sign or signal.

The first part of this invention consists of a mini processor and display unit, with an attached RFID reader. The processor and display unit (approximately: 2 inches high by 6 inches wide by 3 inches deep) is mounted on a bean bag like (optional) self conforming base that sits on the dashboard or other location, within the drivers view. The processor has a quick disconnect wire harness with connections to the vehicles' computer/odometer and power. By unplugging the harness the processor can be removed from the vehicle, or securely stowed within the vehicle. The processor also has a standard USB port for connecting to an Internet enabled device, to obtain system updates or to change existing options.

The RFID reader, which attaches to the processor and display unit via the same quick disconnect wire harness as the power and odometer connection, can be placed anywhere in the vehicle, such as on or under the dashboard, in the engine compartment, etc. The reader will detect RFID tags within approximately 50 feet, regardless of whether they are: embedded in the roadway, on poles (horizontal or vertical) or other objects along the roadway. The RFID reader passes detected information to the processor and display unit, where all known road and traffic signage and signage shapes (such as those displayed in the “Texas Drivers Handbook”, Texas Department of Public Safety) are pre-programmed for quick interpretation and display.

This invention has further applicability, such as in law enforcement where vehicle license plates could be assigned a RFID tag with the plate information, which would then be easy to “read” by law enforcement vehicles equipped with this invention. Additional RFID tags could be used to determine vehicle inspection, registration or insurance status, etc. Further, this invention could be used to alarm when a vehicle or other obstruction is detected within a certain distance ahead or behind, through the use of generic RFID tags attached to other vehicles or objects.

The RFID processor and display unit technology and design of this invention can also be modified and incorporated into a vehicle design by a vehicle or other manufacturer (with appropriate negotiation and agreement by the Inventor), and installed as standard or optional equipment.

The second part of this invention is the RFID tag, which must be supplied or approved by the various municipalities and or government agencies responsible for roadways and vehicle traffic management within their respective jurisdictions. These RFID tags would be unique to the specific international and or local signage or signal, i.e. the STOP sign RFID tag would have a standardized value used nation wide and where applicable, worldwide, a SPEED LIMIT sign would have a standardized RFID tag value for that specific speed, and so on.

### BRIEF DESCRIPTION OF SEVERAL VIEWS OF THE DRAWING

FIG. 1 depicts the processor and display unit, with its 3 display screens.

FIG. 2 depicts an example of a RFID tag placed in a roadbed, and its relationship to an Action event (in this example a Stop sign).

### DETAILED DESCRIPTION OF THIS INVENTION

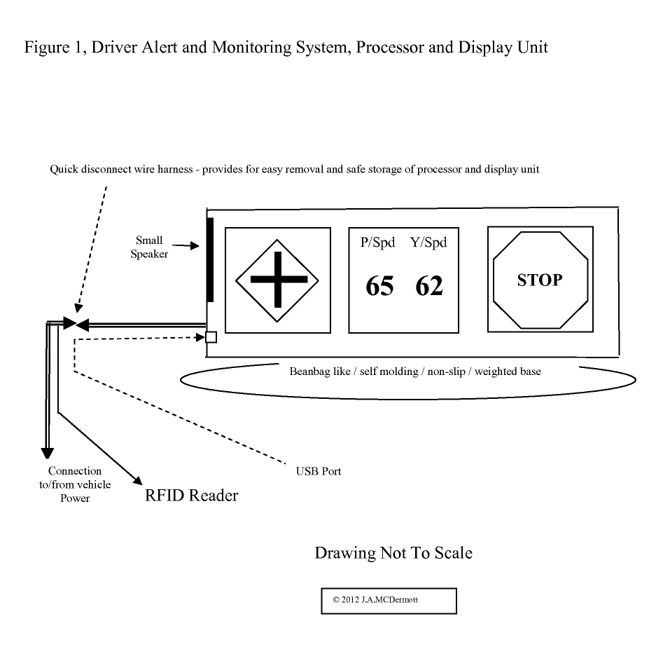

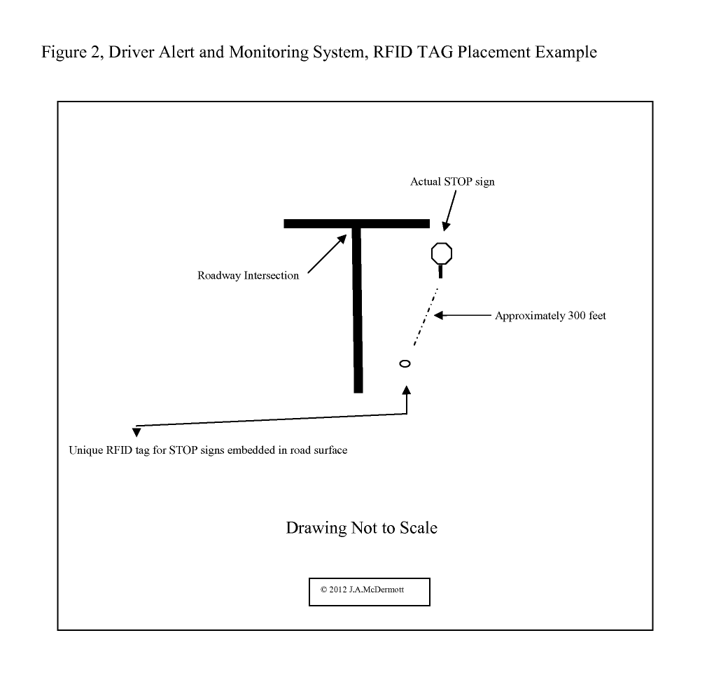

### See Also FIGS. 1 and 2

The processor and display unit (FIG. 1) is the heart of this invention. It is designed to be sleek and non obtrusive while housing: the 3 display screens, the processor, the connecting cable to the vehicle power and computer/odometer, and to the RFID reader device. The unit housing also contains a standard USB port for connecting to an Internet enabled device to receive system updates and options, and a speaker that emits audible signals. The unit can be mounted on a custom made beanbag like weighted base (optional) with non-slip bottom, or it can be mounted directly to any number of locations within the drivers view, using various mounting options (e.g. Velcro).

Details of the processor and display unit (FIG. 1, from left to right) are:
A quick disconnect wire harness, with one side connecting to the processor, the other end having connections to the vehicle power and computer/odometer, and a connecting point for the RFID Reader. The connection to the vehicle computer can be accomplished via the diagnostic connector (in some cases) or other connection points based on vehicle make and model (instructions would be provided).
The RFID READER (a rectangle box approximately 3″×2″×¾″ in size) which can be placed strategically within the vehicle (e.g. on the dashboard, under the dashboard, in the engine compartment, etc.)
A standard USB port (immediately below the wire harness) for connecting the processor to an Internet enabled device for downloading software updates and option changes.
A small speaker located on the left side of the processor box, used for audible signals.
The Processor, a box approximately 2″ high, 12″ long, and 3″ deep, containing the computer or brains of the system and the 3 display screens, the screens being approximately 1.5″ square each.
The DISPLAY SCREENS which are preset so that the left most screen displays WARNING events, the center screed displays SPEED information, and the right most screen displays ACTION events. The front of each screen has 4 buttons, labeled V, W, S, A, V (VOLUME, WARNING, SPEED, and ACTION). The driver can arrange the displays to have them display whatever information they wish by pressing the appropriate button. Note, all three screens can be set to display the same information (e.g. SPEED) if desired. The driver can set the volume of each display as desired.
The display screens also provide audible and animated features that accommodate each event. WARNING events will display the standardized sign image (words, lines, colors) and will be accompanied by a beeping sound. SPEED events will display the last posted speed detected by the system in bold black numbers, and next to that will be the drivers current speed in bold black numbers—UNTIL that speed exceeds the last posted speed, at that point the drivers current speed will change to bold RED numbers that will FLASH and be accompanied by a Morse code like sound. ACTION events will display the actual sign image (words, lines, colors); they will be FLASHING, and will be accompanied by a (repeating) recorded voice, e.g. STOP AHEAD, STOP AHEAD.
An optional beanbag like self molding, weighted non-slip base is shown. This base has a plastic molded top designed to accept the display unit and hold it tightly in place.

The second part of this invention is the RFID tag (FIG. 2), specifically:
They are small pre-programmed, read only, passive tags (passive tags rely on the RFID reader to temporarily “power” them via radio waves as the vehicle approaches the tag)
The tags are placed about 300 feet before the action or information event, and can be: embedded in the road pavement or attached to signs, poles or other objects along the roadway.
These tags must be supplied or approved by the various municipalities and or government agencies responsible for roadways and vehicle traffic management within their respective jurisdictions.
These RFID tags would be unique to the specific international and or local signage or signals, i.e. the STOP sign RFID tag would have a standardized value used nation wide and where applicable, worldwide, a SPEED LIMIT sign would have a standardized RFID tag value for that specific speed, and so on.
   Display Categories and their Associated Traffic Signals, Signs etc., and the Actions They Take

Municipalities and or Government agencies responsible for vehicle traffic control typically enforce such control through road: Signals, Signs, and Markers. This section explains how this invention categorizes the most common of these signals, signs and markers into one of three Events, and then displays them when detected, as follows:
ACTION events. These include: Traffic lights (red, green, and yellow), Stop, Yield, Wrong Way, Do Not Enter, One Way, and School Zone signs, and Railroad Crossing signals and signs, etc. Action events are displayed as a flashing image of the actual signage (e.g. Stop sign) and an audible repeating voice describing the event (e.g. STOP AHEAD, STOP AHEAD)
SPEED events. These include: Posted speed limit signs, School Zone speed limit signs, exit and entry Ramp speed limit signs, Limited sight speed limit signs, etc. This invention compares these posted speeds vs. the actual speed of the vehicle in which this invention is placed (by reading information from the vehicles computer/odometer) and then displays this comparison in real time. Speed displays are in bold black letters unless the vehicle speed exceeds the last posted speed, at which time the vehicle speed display turns red, and flashes, accompanied by a repeating Morse code like sound.
WARNING events. These include warning and other signs such as: Traffic control signal ahead, Do Not Pass, One Way, No U Turn, No Left Turn, Divided highway, Slippery when wet, Ice forms on bridge, Low clearance, Two way traffic ahead, Crossroad ahead, Pedestrian crossing, Reduction in number of lanes, “T” Intersection ahead, Road narrows, Hill, Bump, Dip, Highway intersection ahead, etc. Warning events are displayed by showing an image of the actual signage (e.g. crossroad ahead as shown in FIG. 1) and a beeping sound.

### Government and or Operator Specific Requirements

This invention is designed to be customized such that all categories and their content can be changed to meet: Local, National, or International rules, laws and regulations as required. As such traffic signs, signals and markers can be added or changed, and the factory default English recorded voice for ACTION events, Morse code sound for SPEED events, and the beeping sound for WARNING events, can all be customized by connecting to the manufacturers Web site and selecting a host of signs, signals, markers, languages and sounds.

### Conflicting Alerts

This invention is designed such that ACTION events over-ride all other events should a conflict (several signs of different meanings exist in the same location) exist at the same location. In such cases the ACTION event (i.e. RED LIGHT) will be displayed with the appropriate audible sound. Should there be conflicting ACTION events at the same location, the system will display the words MULTI-ACTIONS AHEAD in the ACTION display screen, along with the same words repeated as an audible warning.

This invention also displays only the RFID tags that are “straight on” meaning full facing the RFID reader and vehicle. This prevents “false positives” where, as an example, when approaching a crossroad intersection, the perpendicular roads have STOP signs, but the road the vehicle is traveling on does not. Since the RFID tags for the STOP signs on the perpendicular roads would not be “straight on” (and likely out of range) to the vehicle with this invention, they would be disregarded by this invention. However the WARNING display of “CROSSROAD AHEAD” would be displayed if in fact there were such a CROSSROAD sign and associated RFID tag in the vehicles line of travel.

To ensure there is no confusion, ACTION and WARNING display screens go blank as soon as the EVENT that triggered their display is passed.

1. This invention proactively yet unobtrusively alerts a vehicle operator of events that require action or potential action by them (e.g. STOP or SCHOOL ZONE or CROSSROAD ahead, etc.), and enables the operator to monitor their SPEED as compared to the last posted speed, so that they can make adjustments as necessary.

2. This invention overcomes many obstacles that make reading and deciphering road signage and signals difficult, because it uses radio frequency technology which in most cases can see through obstructions such as fog, rain, smoke, mist, shrubbery, buildings, etc.

3. This invention greatly reduces the potential for accidents by alerting vehicle operators who may be otherwise inattentive, distracted, or occupied with other activities (e.g. email) to events that require their immediate or soon to be required action.
